(19) United States
(12) Patent Application Publication
(10) Pub. No.: US 2006/0207021 A1
(43) Pub. Date: Sep. 21, 2006

(54) Multi-directional personnel lift

(75) Inventors: Kevin K. Brunson, Aledo, TX (US); Darrell S. Caldwell, Glen Rose, TX (US); Clifton E. Thomas, Nacogdoches, TX (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: K.B. Aviation, Inc. d/b/a Brunson Associates

(21) Appl. No.: 11/334,684

(22) Filed: Jan. 18, 2006

Related U.S. Application Data
(60) Provisional application No. 60/645,320, filed on Jan. 19, 2005.

(51) Int. Cl. A61G 7/10

(52) U.S. Cl. 5/81.1 R; 5/611

(57) ABSTRACT

The present invention relates to personnel lifts for positioning a subject relative to a work space. Lifts of the invention may include a base, a mechanical positioner, a platform, and a controller. Controllers suitable for use with lifts of the invention are preferably capable of directing continuous, intermittent, periodic, or sporadic adjustment of the subject's position without requiring the subject to break visual or tactile contact with the work space.

### RELATED APPLICATION

This application claims priority to U.S. Provisional Patent Application Ser. No. 60/645,320, filed Jan. 19, 2005 and entitled “MULTI-DIRECTIONAL PERSONNEL LIFT,” the contents of which are hereby incorporated in their entirety by reference.

### TECHNICAL FIELD

The present invention is related to a device for positioning a person relative to a work space.

### BACKGROUND OF THE INVENTION

In certain work situations it is critically important for those performing a task to possess the ability to optimize hand placement and to maintain the best line of sight during a particular step in the process. Work performed over long periods of time, especially during times when delicate, tedious procedures are involved, can require several steps, and the need for several different positions and ergonomic relationships. As one example, an optimal ergonomic relationship between a doctor and his/her patient is particularly critical in situations such as conducting surgical procedures within an abdominal cavity.

The achievement and maintenance of the optimal ergonomic relationship between one performing work and a work space can reduce the time, energy, effort and cost of performing a work function. It can also reduce the possibility of acute workplace injuries though improvisation, such as using makeshift devices such as stools, ladders, crates, buckets, and could reduce the occurrence of chronic injuries due to improper body, neck, hand, and head placement over extended periods of time.

In healthcare, the ergonomic relationship a surgeon and a patient can directly affect the difficulty, time, safety, expense, and outcome of a surgical procedure. Where the relationship between the patient and health care worker is less than optimal, patient health may be adversely affected by resulting trauma to tissues, increased time under anesthesia, exposure. The overall quality of repairs to vital organs, nerves and tissues may suffer.

State of art in the industrial workplace involves adjustable lifts, platforms and hoists for parts, sub-assemblies, and completed components. Examples include hydraulic motorcycle lifts, rotary tables, automotive hoists, hydraulic platforms and tables. State of the art in the healthcare field would include operating and exam tables, hydraulic lifting devices, hoists, cranes, and certain positioning devices. In these cases, it is the work space that is moved, not the subject who performs a task in the work space.

### SUMMARY OF THE INVENTION

In accordance with teachings of the present invention, a personnel lift is provided for positioning a worker relative to a work space. A lift of the invention may include a base and a platform and may be configured to accommodate one or more people. In one aspect of the inventions the platform is movable in one, two, or three dimensions and suitable for holding a surgeon or other medical professional during a health-related procedure. For example, in some non-limiting embodiments, the invention provides a lift for positioning and conveying a health care worker in and around a patient or surgical field. More specifically, a lift may be configured to comfortably and ergonomically hold a surgeon in a desired position during a bariatric procedure.

The weight of subjects on the lift or other loads may be counter-balanced by the mass of the lift itself. In some embodiments, a lift may include counter-balancing weights, which may be positioned in one or more locations in or on the lift. In some embodiments, the lift may be reversibly or permanently anchored to the surface on which it rests (e.g. the floor). Lifts may also be reversibly or permanently anchored to a wall or ceiling. Reversible anchors may include any type of suction devices, bolts, or quick releases. Lifts of the invention may also be reversibly or permanently attached to an operating table. For example, in some embodiments, a lift of the invention includes or is integrated into an operating table. In such embodiments, the subject on the lift (e.g. the surgeon) is moved relative to the work space (e.g. operating field), but the work space is not moved relative to the surroundings (e.g. the operating room).

Lifts of the invention may include a mechanical positioner capable of moving the platform in one, two, or three dimensions. The mechanical positioner may include a power supply, a motor, a scissor truss, a piston, a threaded member, a jack, a gear, a belt, a clutch, a rail, a track, a spring, a pump, a bladder, a drive wheel, a drive ball, casters, a conveyor belt, and combinations thereof. Lifts of the invention may include a controller operably linked to a mechanical positioner to control the direction and degree of movement of the platform. The controller may be actuated while allowing the subject to maintain visual and/or tactile contact with the work space. This may be particularly useful in the medical aspects of the present invention, where loss of visual or tactile contact with the patient may compromise the efficacy or safety of the procedure. By contrast, hand-operated controls may increase the risk of infection and preclude simultaneously executing a medical procedure and adjusting the lift's position. In some embodiments, the controls may be actuated by the subject, e.g. the surgeon. In some embodiments, the controls may be actuated by an assistant. In such embodiments, the assistant may or may not be on the lift when actuating the controls.

Controllers suitable for use in lifts of the invention include any type of mechanical or electrical apparatus capable of receiving instructions from a subject and selectively activating the mechanical positioner such that the subject is moved to the instructed location. Controllers of the invention may be active continuously, intermittently, periodically, or upon demand. In some embodiments, the controller may be retracted or covered to prevent inadvertent activation when not in use. In one non-limiting example, foot-operated or touch-sensitive controls on the surface of a platform may be covered or locked so that further contact does not result in undesired or inadvertent platform movement.

Platforms of the invention may be of any size or shape. Possible platform shapes include any type of regular or irregular two-or three dimensional shape. For example, platforms may be configured in the shape of any type of regular or irregular polygon (when viewed from above) including, without limitation, a triangle, any type of parallelogram, and any type of curvilinear shape. According to some embodiments of the invention, platforms may be generally rectangular and have a length of from about nineteen inches to about thirty-six inches and a width of from about thirty inches to about forty-eight inches. In some embodiments, the platform preferably has a length of twenty-four inches and a width of about thirty-six inches.

Lifts of the invention may be configured to raise one or more subjects any desired distance from the surface on which the lift rests or any other reference point. In some non-limiting embodiments, lifts of the invention are capable of raising a subject from about six inches to about ninety-six inches from the surface on which the lift rests. It may be desirable, for certain embodiments, to configure the lift to raise the subject 6″-18″, 19″-36″, 37″ to 60″, or 61″ TO 96″ from the surface on which the lift rests. In addition, lifts of the invention may include one or more platforms, each of which may be independently or coordinately controlled.

Lifts according to the present invention may also include a tilting platform with any number of desired or required supports, pads, and harnesses to put the subject at ease while performing a task in the work space. For example, each platform of the invention may include chest bolsters, hip bolsters, thigh bolsters, and shin/calf bolsters that may or may not completely encircle the body part supported.

One of ordinary skill in the art will recognize that lifts of the invention may be useful in other contexts including, automotive repairs, painting, sculpturing, household repairs, and manufacturing. In addition, lifts of the present invention may be used to position a subject relative to a work space such that the work space is above, level with or below the subject's center of mass.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1A is a schematic drawing in elevation showing a lift of the invention in its home position;

FIG. 1B is a schematic drawing in elevation showing a lift of the invention in an elevated position;

FIG. 1C is a schematic drawing showing a plan view of the platform of the lift shown in FIGS. 1A and 1B;

FIG. 2A is a schematic drawing in elevation showing a lift of the invention in its home position;

FIG. 2B is a schematic drawing in elevation showing a lift of the invention in an elevated position;

FIG. 2C is a schematic drawing showing a plan view of the platform of the lift shown in FIGS. 2A and 2B;

FIG. 3A is a schematic drawing in elevation showing a lift of the invention in its home position;

FIG. 3B is a schematic drawing showing an end view of the lift shown in FIG. 3A;

FIG. 3C is a schematic drawing in elevation showing a lift of the invention in an elevated position;

FIG. 3D is a schematic drawing showing a plan view of the platform of the lift shown in FIGS. 3A, 3B and 3C;

FIG. 4A is a schematic drawing in elevation showing a lift of the invention in its home position;

FIG. 4B is a schematic drawing in elevation showing a lift of the invention in an elevated position;

FIG. 4C is a schematic drawing showing a plan view of the platform of the lift shown in FIGS. 4A and 4B;

FIG. 5A is a schematic drawing in elevation showing a lift of the invention in its home position;

FIG. 5B is a schematic drawing in elevation showing a lift of the invention in an elevated position;

FIG. 5C is a schematic drawing showing a plan view of the lift shown in FIGS. 5A and 5B;

FIG. 6A is a schematic drawing of a cross-section of corner of a lift of the invention in its home position;

FIG. 6B is a schematic drawing showing an isometric view of a lift of the invention in its home position;

FIG. 6C is a schematic drawing showing an isometric view of a lift of the invention in its elevated position;

FIG. 7A is a schematic drawing of a cross-section of corner of a lift of the invention in its home position;

FIG. 7B is a schematic drawing showing an isometric view of a lift of the invention in its home position;

FIG. 7C is a schematic drawing showing an isometric view of a lift of the invention in a partially elevated position;

FIG. 7D is a schematic drawing showing an isometric view of a lift of the invention in a partially elevated position;

FIG. 7E is a schematic drawing showing an isometric view of a lift of the invention in its fully elevated position;

FIG. 8A is a schematic drawing in elevation showing a lift of the invention in its home position;

FIG. 8B is a schematic drawing in elevation showing a lift of the invention in an elevated position;

FIG. 8C is a schematic drawing showing a plan view of the lift shown in FIG. 8B;

FIG. 8D is a schematic drawing showing an isometric view of the lift shown in FIGS. 8B and 8C;

FIG. 9 is a schematic drawing showing an isometric view of a lift of the invention in an elevated position;

FIG. 10A is a schematic drawing in elevation showing a lift of the invention in its home position;

FIG. 10B is a schematic drawing in elevation showing a lift of the invention in an elevated position;

FIG. 11A is a schematic drawing showing an isometric view of a lift of the invention in its start position;

FIG. 11B is a schematic drawing showing an isometric view of the lift shown in FIG. 11A in its elevated position;

FIG. 11C is a schematic drawing showing an isometric view of the lift shown in FIG. 11B in a laterally-shifted position;

FIG. 11D is a schematic drawing showing an isometric view of the lift shown in FIG. 11C in a forward-shifted position;

FIG. 11E is a schematic drawing showing a plan view of the lift shown in FIG. 11A in a laterally-shifted, forward-shifted position;

FIG. 12A is a schematic drawing showing an isometric view of a lift of the invention in its start position;

FIG. 12B is a schematic drawing showing an isometric view of the lift shown in FIG. 12A in its elevated position;

FIG. 13A is a schematic drawing showing an isometric view of a lift of the invention in its mobile position;

FIG. 13B is a schematic drawing in elevation showing the lift shown in FIG. 13A in its mobile position;

FIG. 13C is a schematic drawing in elevation showing the lift shown in FIG. 13B in its start position;

FIG. 13D is a schematic drawing showing a plan view of the base of the lift shown in FIGS. 13A-13C;

FIG. 14 is a schematic drawing in elevation showing a lift of the invention;

FIG. 15 is a schematic drawing showing an isometric view of a platform of the invention;

FIG. 16 is a schematic drawing showing an isometric view of a platform of the invention; and

FIG. 17 is a schematic drawing showing an isometric view of a platform of the invention.

### DETAILED DESCRIPTION OF THE INVENTION

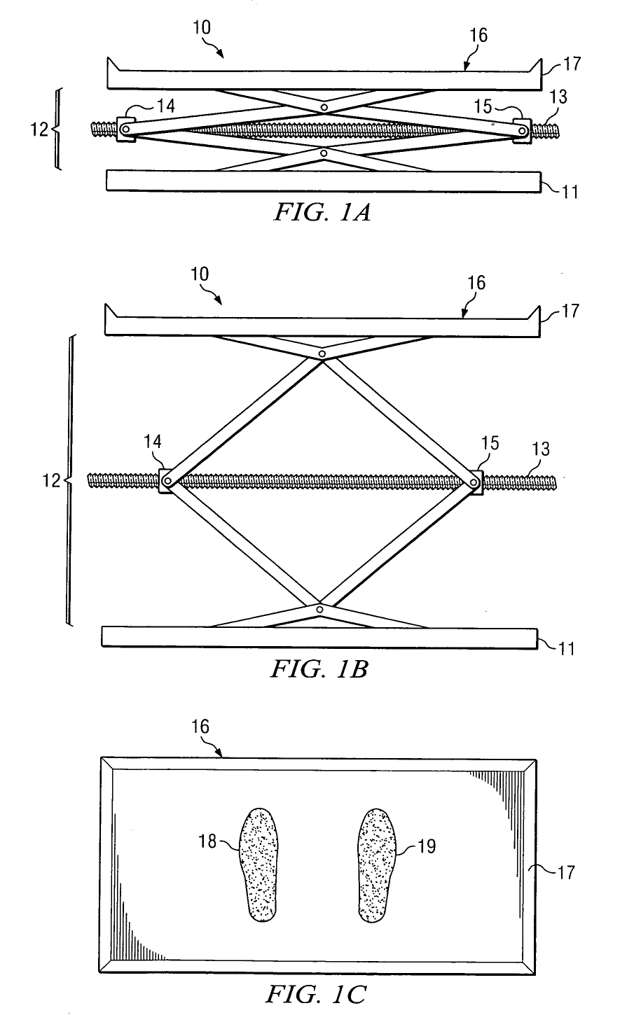

Preferred embodiments of the invention and its advantages are best understood by reference to FIGS. 1-8 wherein like number refer to same and like parts. Table 1 lists reference numerals with their associated names and figures in which they appear.

In some non-limiting embodiments of the invention, a multi-dimensional lift may comprise a means for moving a subject along an x-axis. In some non-limiting embodiments of the invention, a multi-dimensional lift may comprise a means for moving a subject along a y-axis. In some non-limiting embodiments of the invention, a multi-dimensional lift may include a means for moving a subject along a z-axis. The x-axis, y-axis, and z-axis may be perpendicular to each other. The lift may be positioned such that the x-axis and y-axis are parallel to the plane of the surface on which the lift rests.

In the non-limiting embodiment shown in FIG. 1, the means for moving a subject along a z-axis may include scissor truss 12 and screw 13 operably engaged thereto, as shown in FIGS. 1A and 1B. As screw 13 turns, the distance between joints 14 and 15 is reversibly reduced. This movement results in the elevation of platform 16 above base 11 from the start position shown in FIG. 1A to the raised position shown in FIG. 1B.

Platform 16 may include foot pads 18 and 19 as shown in FIG. 1C. Foot pads of the invention may be ergonomically molded for added comfort. Platform 16 may also include low-rise perimeter rail 17. This rail may serve a variety of functions including, without limitation, giving the worker a tactile indicator of proximity to the platform's edge and containing fluids, debris, or other materials associated with performance of the task at hand. The rail may also be configured to include touch-sensitive controls. Platform 16, like other platforms suitable for use with lifts of the invention may be from about thirty inches to about fifty inches long by about nineteen inches to about thirty inches wide.

Foot pad 18 and foot pad 19 may each be made of a resilient material for comfort. These pads may be any size or shape. Although not expressly show, lift 20 may be combined with other means of positioning a subject in a second or third dimension.

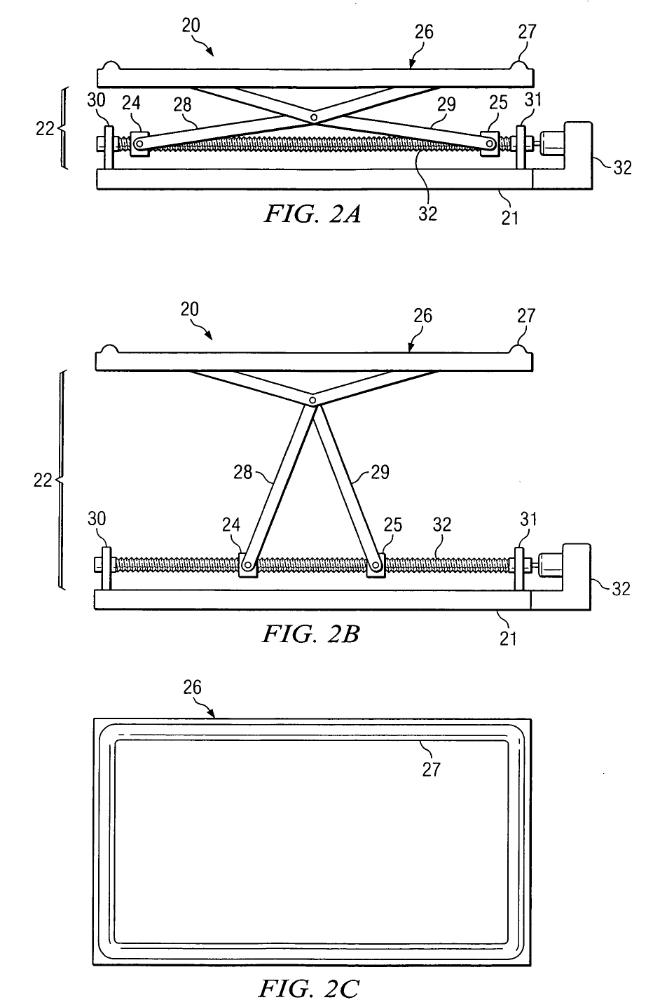

According to the non-limiting embodiment shown in FIG. 2, the means for moving a subject along a z-axis may include truss 22. Struts 28 and 29 of truss 22 may be movably connected to threaded rod 32 by threaded rings 24 and 25. Threaded rod 32 is attached to base 21 by mount 30 and mount 31. Mount 30 and mount 31 may be coupled with threaded rod 32 such that threaded rod 32 it is free to rotate but longitudinally fixed. Mount 30 and mount 31 may be fixed to base 21. Motor 33 may be operably linked to threaded rod 32 to rotate threaded rod 32 about its longitudinal axis. Such rotation of threaded rod 32 closes the distance between threaded ring 24 and threaded ring 25 and reversibly raises platform 26 above base 21 from the start position shown in FIG. 2A to the elevated position shown in FIG. 2B.

Platform 26 may include low-rise perimeter ridge 27. This ridge may serve a variety of functions including, without limitation, giving the worker a tactile indicator of proximity to the platform's edge and containing fluids, debris, or other materials associated with performance of the task at hand. Ridge 27 may also be configured to include touch-sensitive controls (not expressly shown). The surface of platform 26 may made of or covered with a resilient material for comfort.

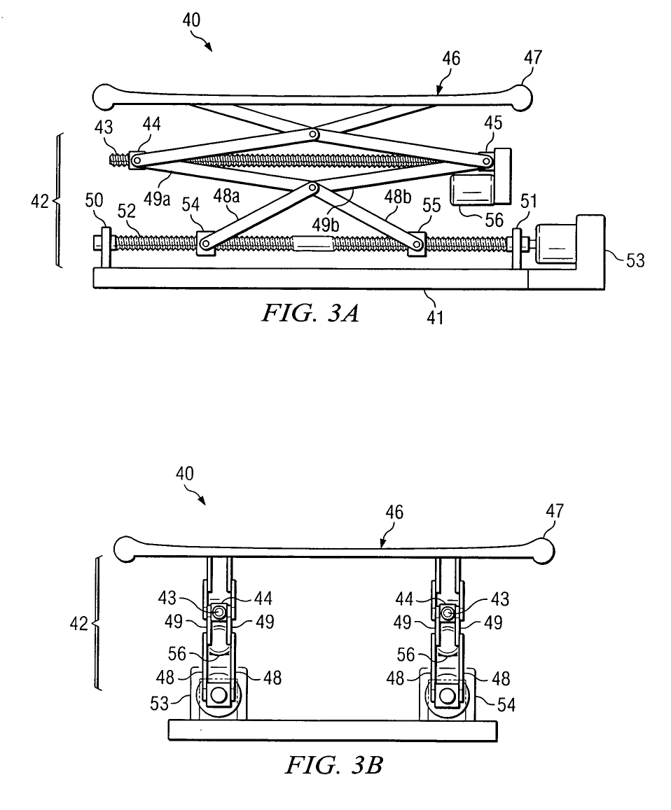

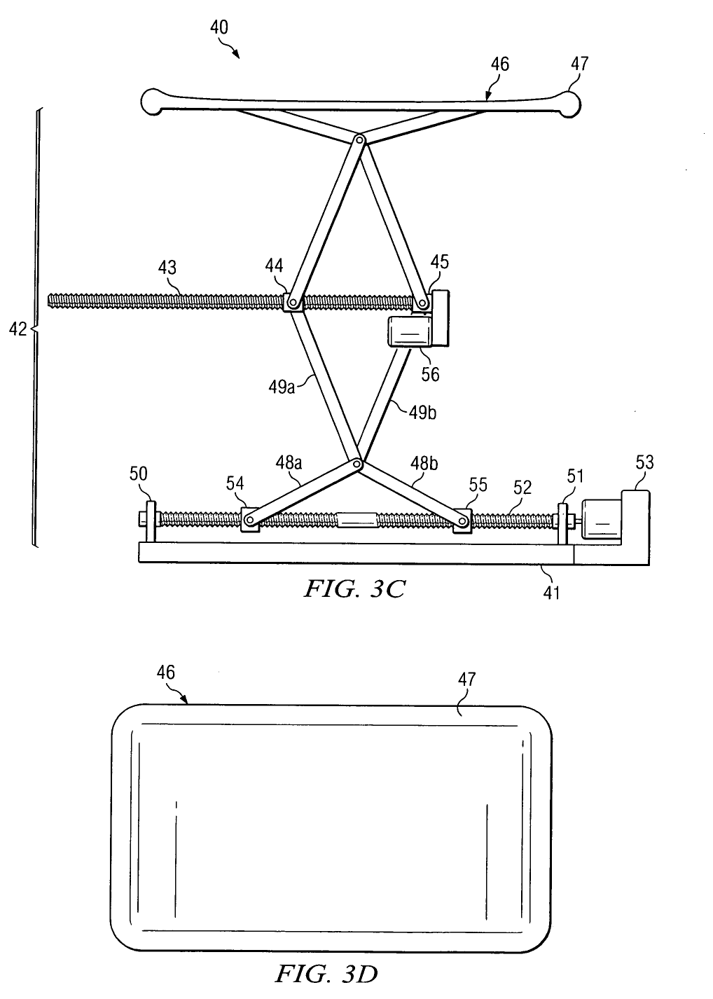

According to the non-limiting embodiment shown in FIGS. 3A-3D, lift 40 according to the teachings of the invention may include means for moving a subject along both an x-axis and a z-axis. The means for moving a subject along an x-axis may include threaded rod 52 rotatably coupled with mount 50 and mount 51 and fixed to base 41. The means for moving a subject along an x-axis may further include threaded ring 54 and threaded ring 55. Threaded rings 54 and 55 may be movably coupled with threaded rod 52. In addition, struts 48a and 48b may be fixed to each other at a preset angle at one end and rotatably attached at the opposite ends to threaded rings 54 and 55. Struts 48a may be attached to opposite sides of threaded ring 54 for enhanced strength and/or stability. Although not expressly shown, struts 48a may be a single, solid piece that spans the width of threaded ring 54. Rotation of threaded rod 52 by operably linked motor 53 may move threaded rings along the longitudinal axis of threaded rod 52.

The means for moving a subject along a z-axis may include scissor truss 42 and screw 43 operably engaged thereto, as shown in FIGS. 3A, 3B and 3C. As screw 43 is turned by operably linked motor 56, the distance between joints 44 and 45 is reversibly reduced. This movement results in the elevation of platform 46 above base 41 from the start position shown in FIG. 3A to the raised position shown in FIG. 3C. Platform 46 may include perimeter bulge 47. The surface of platform 46 may be radially graded such that together with bulge 47 it forms a shallow bowl.

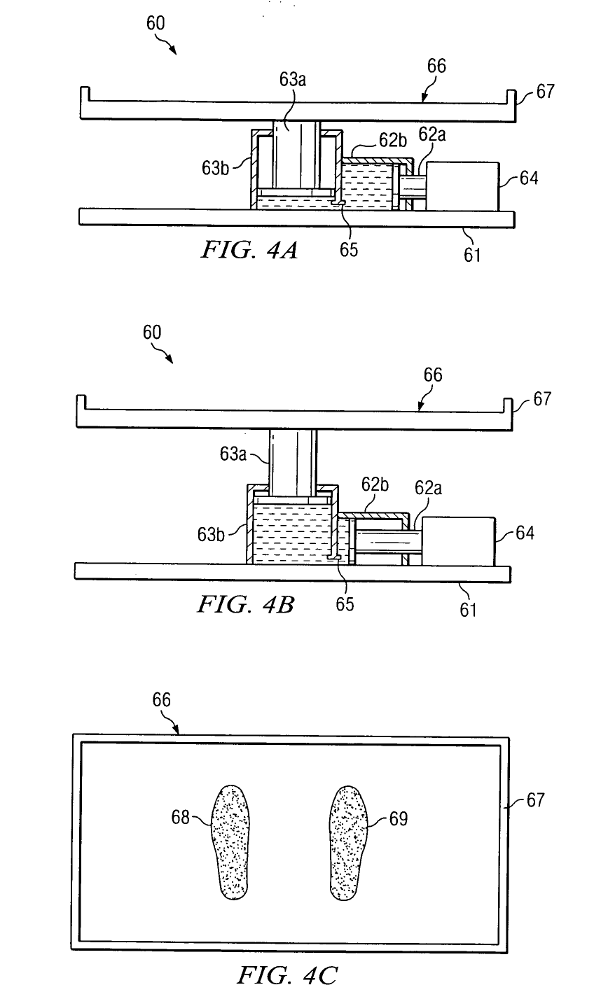

According to the non-limiting embodiment shown in FIG. 4, the means for moving a subject along a z-axis may include base 61, platform 66, and hydraulic pistons. Horizontal piston 62a and chamber 62b may be operably linked to vertical piston 63a and chamber 63b. According this embodiment, motor 64 drives piston 62a into chamber 62b forcing hydraulic fluid through valve 65 into chamber 63b. This in turn causes piston 63a and, therefore, platform 66 to rise above base 61 from the start position shown in FIG. 4A to the elevated position shown in FIG. 4B. Platform 66 may be lowered by opening valve 65 to allow hydraulic fluid to flow back into chamber 62b. Platform 66 may include perimeter rail 67 and foot pads 68 and 69 as shown in FIG. 4C. Although not expressly shown, lift 60 may be configured to include voice-activated or foot actuated controls. Lift 60 may also be combined with other components to move the subject in along an x-axis and/or a y-axis.

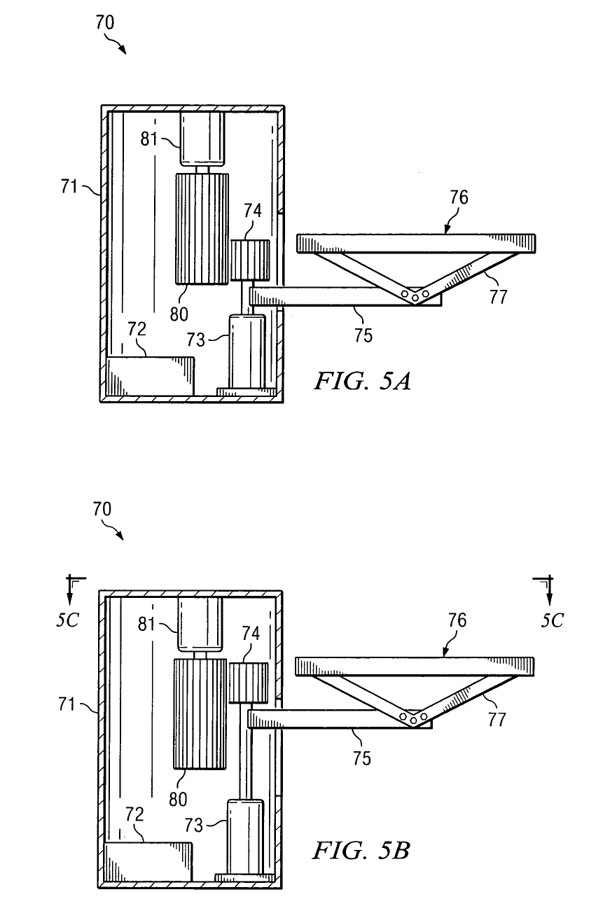

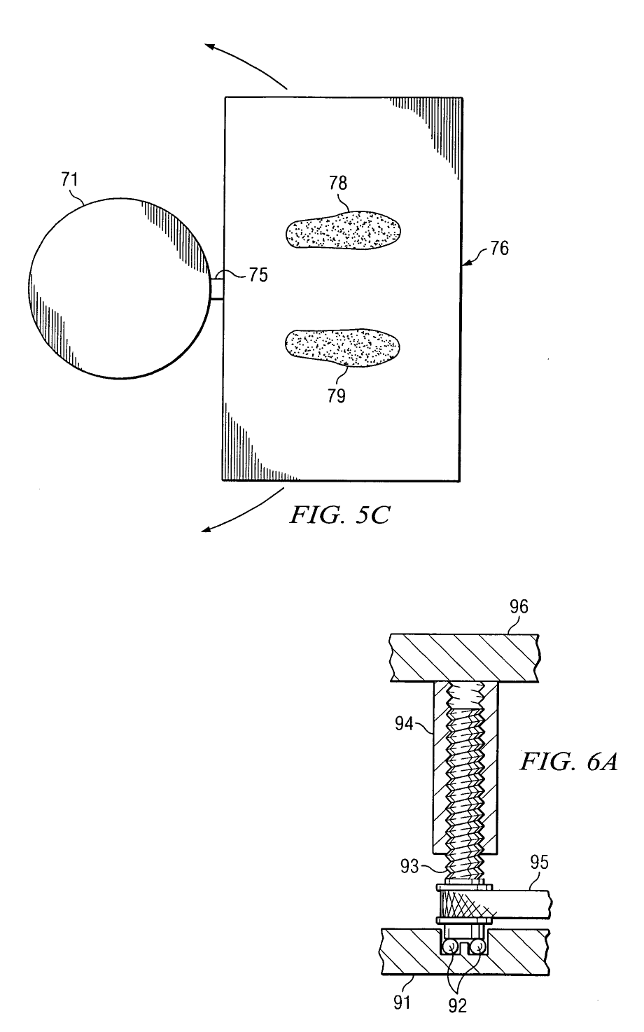

According to the non-limiting embodiment shown in FIG. 5, lift 70 according to the teachings of the invention may include a means for moving a subject along an x-axis, a y-axis, and a z-axis. The means for moving a subject along a z-axis may include base 71, jack 73, gear 74, arm 75, platform 76, and support 77. Support 77 may be fixed to arm 75 and platform 76 and arm 75 may be fixed to gear. Gear 74 is attached to the top of jack 73 such that it may rotate about an axis that is parallel to the longitudinal axis of jack 73. Elevation of jack 73 in turn elevates platform 76 from the start position shown in FIG. 5A to the elevated position shown in FIG. 5B. Lift 70 may also include a means for moving a subject in an x-z plane. The means for moving a subject in an x-z plane may include motor 81, gear 80, and gear 74, wherein motor 81 rotates gear 80 and gear 80 is operably engaged with gear 74. Rotation of gear 80 by motor 81 in turn rotates gear 74. This causes platform 76 to rotate about the longitudinal axis of gear 74 in a plane that is parallel to both the x-axis and the y-axis (FIG. 5C). Platform 76 may also include foot pads 78 and 79 as shown in FIG. 5C. Lift 70 may further include weight 72 to counter balance the weight of platform 76 with a subject resting thereon. The size and shape of base 71 may also be modified to counter balance platform 76 and stabilize lift 70. Although not expressly shown, arm 75 may be a telescoping arm to improve the subject's access to a work space.

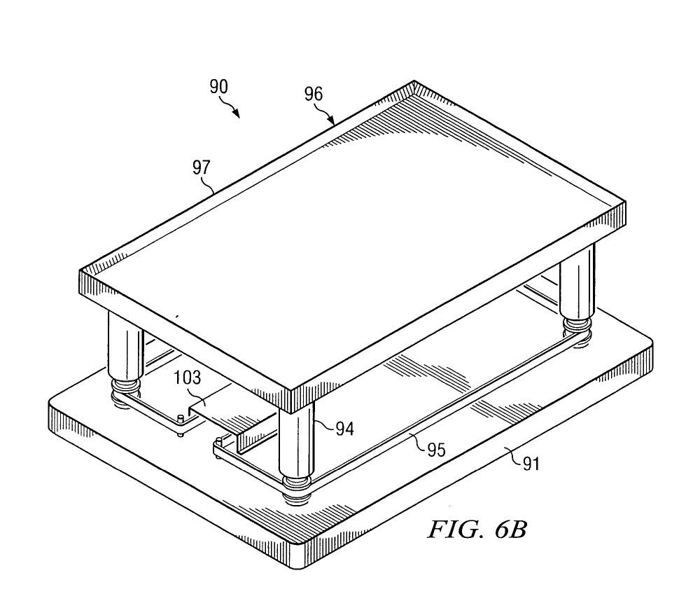

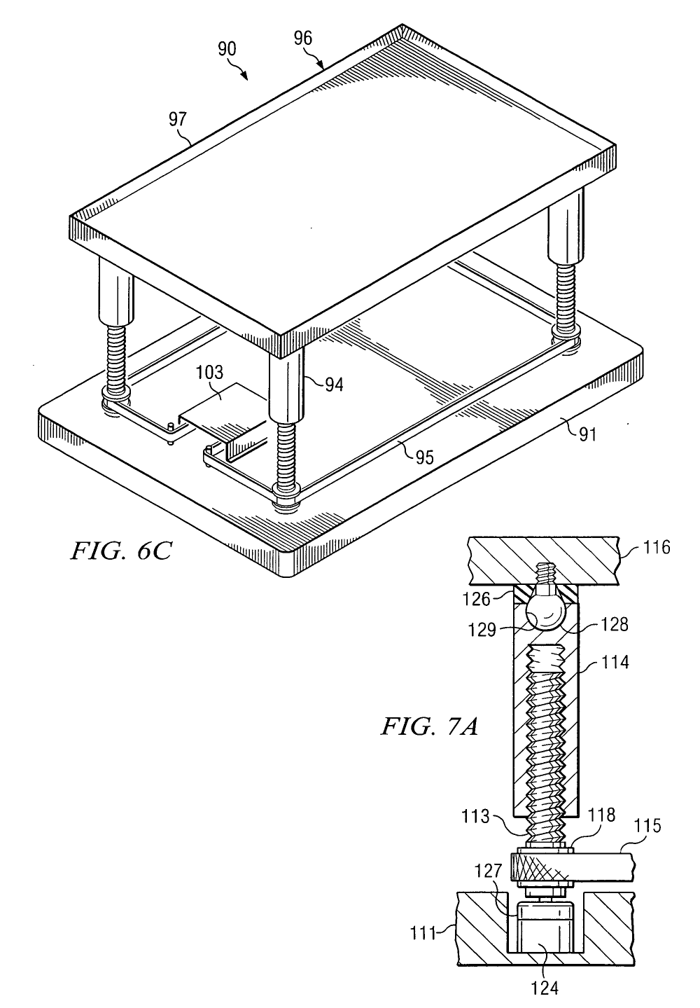

According to the non-limiting embodiment shown in FIG. 6, the means for moving a subject along a z-axis may include a belt-driven elevation system. This system may include bearings 92, threaded piston 93, threaded cylinder 94, and belt 95. As shown in FIG. 6A, bearings 92 are movably contained in recessed pockets in base 91. Threaded piston 93 abuts bearings 92 and is operably connected to belt 95. Threaded piston 93 is inserted into threaded cylinder 94. Platform 96 is fixed to threaded cylinder 94 and may include perimeter angled rail 97. Belt 95 is driven by motor 103. Rotation of threaded piston 93 by belt 95 reversibly raises threaded cylinder 94 and therefore, platform 96 from its start position shown in FIG. 6B to its elevated position shown in FIG. 6C. The degree of control over positioning along the z-axis may be selected by adjusting the number of threads per inch with high numbers allowing finer control. The speed of elevation may be selected by adjusting the speed of motor 103, for example where motor 103 is a variable speed motor. Although not expressly shown, threaded piston 93 and cylinder 94 may include an anti-backdown control to prevent unwanted platform movement such as that which may occur in the case of belt slippage or failure. Although not expressly shown, lift 90 may also be configured to afford movement along an x-axis or a y-axis.

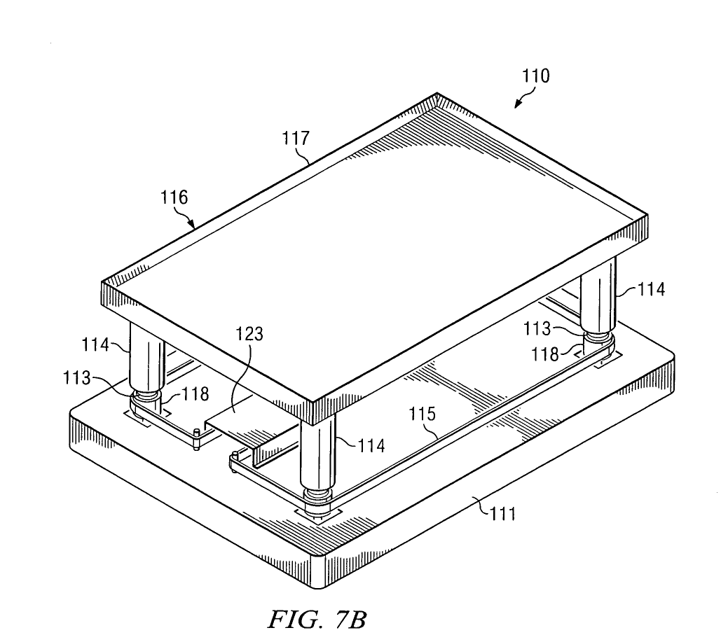

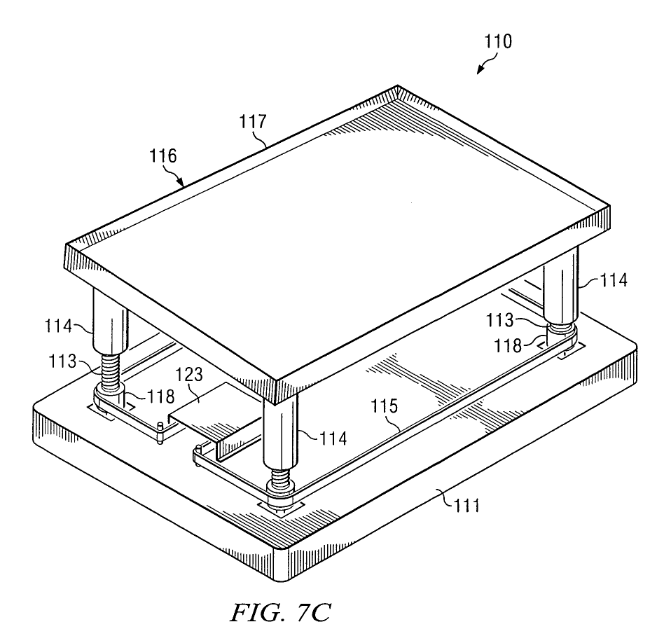

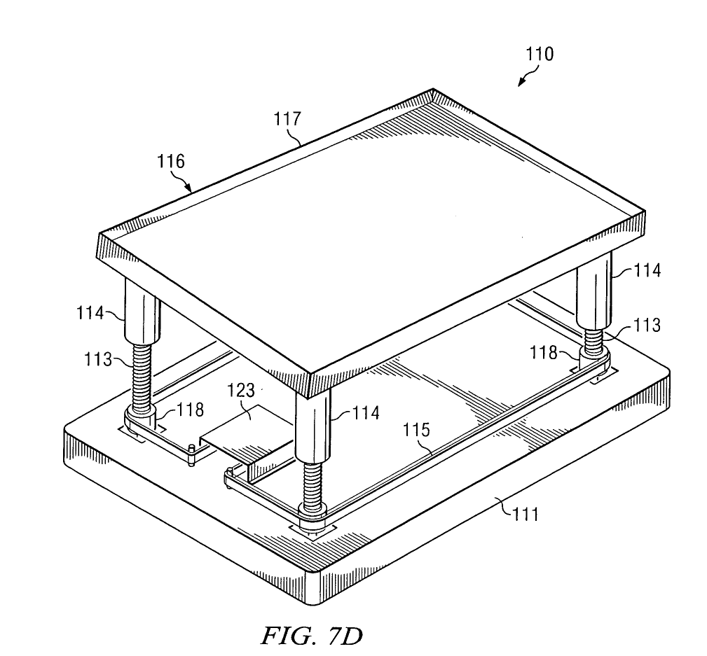

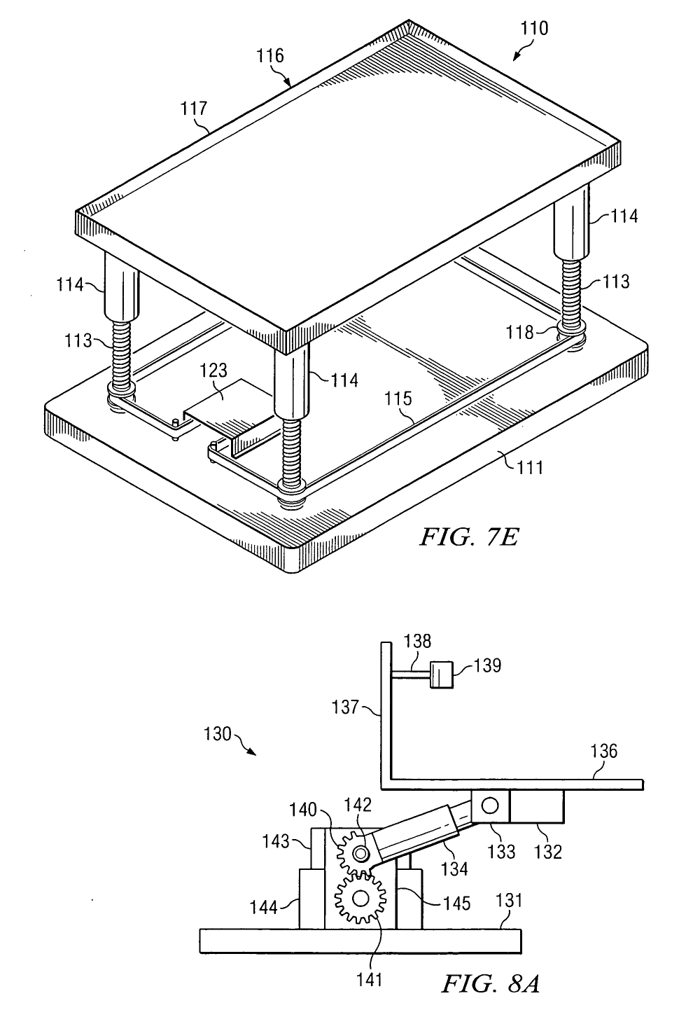

A non-limiting, tiltable variation of the embodiment shown in FIG. 6 is shown in FIG. 7. As shown in FIG. 7A, lift 110 differs from lift 90 in that each threaded piston 113 has an underlying clutch 128 and motor 124 within base 111. In addition, threaded piston 113 is rotatably coupled with belt 115 via clutch 118. Platform 116 is flexibly coupled to threaded cylinder 114 by ball 128 and socket 129. Although other configurations are possible, as shown in FIG. 7A, ball 128 is fixed to platform 116 and socket 129 is fixed to threaded cylinder 114. Threaded cylinder 114 is rotatably fixed to platform 116 by resilient annulus 126. Platform 96 may include perimeter angled rail 97.

When clutch 118 is engaged, threaded piston 113 may be rotated by belt 115. Clutch 127 may or may not be disengaged while threaded piston 113 is rotated by belt 115. When clutch 118 is disengaged and clutch 127 is engaged, threaded piston 113 may be rotated by motor 124, but not belt 115. Thus, the z-axis position of each piston may be adjusted independently and/or coordinately. As a result, platform 116 may be tilted by partial elevation of one or more pistons. FIG. 7C shows the tilt resulting from modest elevation of the left-most piston and partial elevation of front and rear pistons. This tilt angle may be maintained while elevating the entire platform by disengaging clutches 127, engaging clutches 118, and rotating belt 115 as shown in FIG. 7D. Motor 123, clutches 118, motors 124, and clutches 127 may be electrically coupled to each other or to a controller (not expressly shown) to achieve synchronous or asynchronous control. Thus, controller may be configured to adjust the roll, pitch, and yaw of platform 116. A controller may be configured to obviate the need for motor 123 and clutches 118 by coordinately operating motors 124 and clutches 127.

As with other embodiments of this invention, lift 110 may be configured to also include means of moving a subject along an x-axis and/or a y-axis. Lift 110 may also include any type of control mechanisms including means of hands-free control such as voice-activated controls and foot-activated controls. In applications where the subject may be on the lift for an extended period of time with the platform in a tilted position, it may be desirable to include one or more braces, boslters, or pads to support the subject's weight. Such supports may be fixed to platform 96 or base 91.

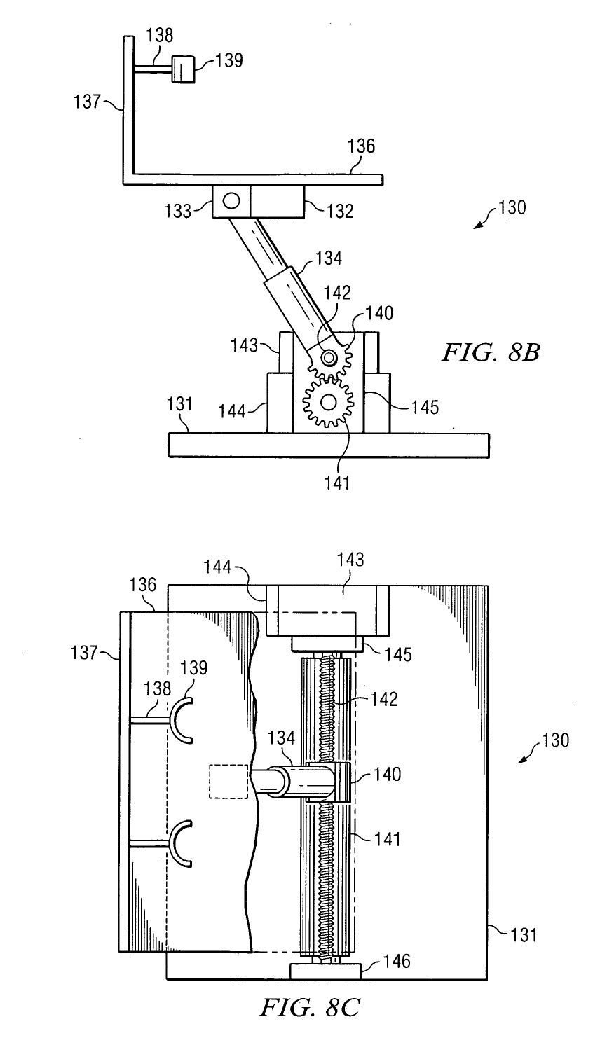

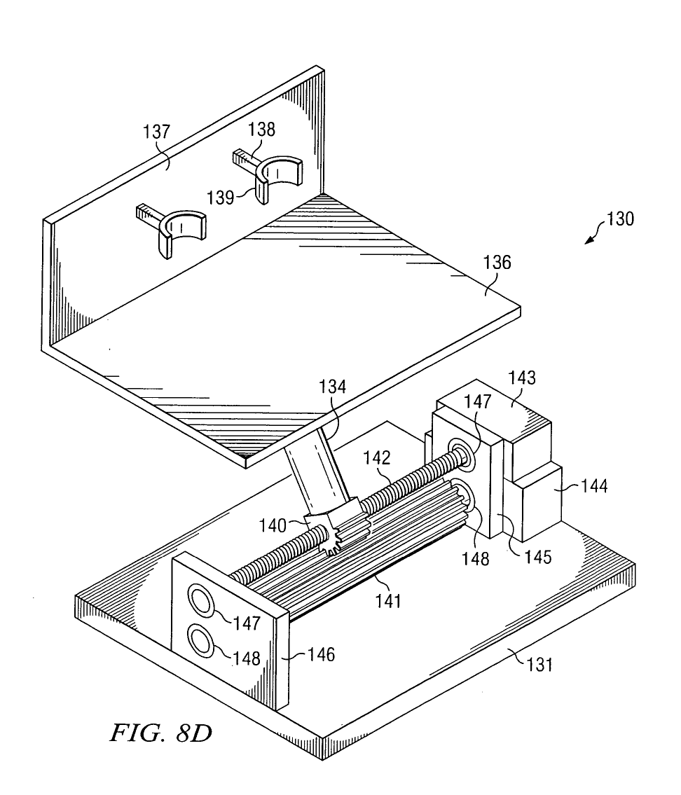

According to the non-limiting embodiment shown in FIG. 8, the means for moving a subject in an x-z plane may comprise piston 134, platform 136, threaded gear 140, and gear rod 141. As shown in FIG. 8A, platform 136 may have motor 132 mounted thereon. Motor 132 may be operably connected to gear box 133 through which it may control the degree of the angle formed by the longitudinal axis of piston 134 and surface of platform 136 (“platform angle,”) (FIG. 8B). Piston 134 may also be operably linked to gear box 133. Motor 144 may be operably linked to gear rod 141, through which it may control the degree of the angle formed by the longitudinal axis of piston 134 and surface of base 131 (“base angle,”) (FIG. 8B). Piston 134 may be operably linked to gear rod 141 through threaded gear 140. Although not expressly shown, motors 132 and 144 may be electronically or mechanically linked to maintain a desired sum of platform angle and base angle. For example, to keep platform 136 level, the sum of these angles would be maintained at 180°. To tip platform 136 toward the work space, the sum of these angles may be reduced below 180°. Alternatively, to tip platform 136 away from the work space, the sum of these angles may be increased above 180°.

As shown in FIG. 8B, expansion of piston 134 increases the range of possible movement in the x-z plane. This expansion may be achieved by operably linking piston 134 to motor 132. In this case, motor 132 may drive a pump (not expressly shown) that reversibly fills piston 134 with hydraulic fluid.

As shown in FIG. 8C, lift 130 may be configured to include a means of moving a subject along a y-axis. The means of moving a subject along a y-axis may include threaded gear 140, threaded rod 142 and motor 143. It may also include piston 134 and platform 136. Movement along a y-axis may be achieved where threaded rod 142 is rotated about its longitudinal axis such that threaded gear 140, the female threads of which are operably engaged with the male threads of threaded rod 142, moves in a positive or negative direction along the longitudinal axis of threaded rod 142, which is the y-axis itself or parallel to the y-axis. This results in movement of the subject resting on platform 136 along a y-axis since platform 136, gear box 133, and piston 134 are all fixed to threaded gear 140, at least with respect to the y-axis.

As shown in FIG. 8D, gear rod 140 and threaded rod 142 may preferably be parallel to each other. The ends of gear rod 140 and threaded rod 142 may each be rotatably mounted on supports 145 and 146 through hubs 147 and 148. Supports 145 and 146 may be fixed to base 131.

Shin rests 135 may be fixed or adjustably mounted on platform 136 through arms 138 and rail 137. Other types of ergonomic features may be elaborated on platform 136 or any other platform of the invention including, without limitation, foot pads, knee supports, hip rests, harnesses (e.g. leg harnesses or waist belts), and seats. Platform 136 may also be configured to include additional railings, proximity detectors, hands-free controls, or combinations thereof.

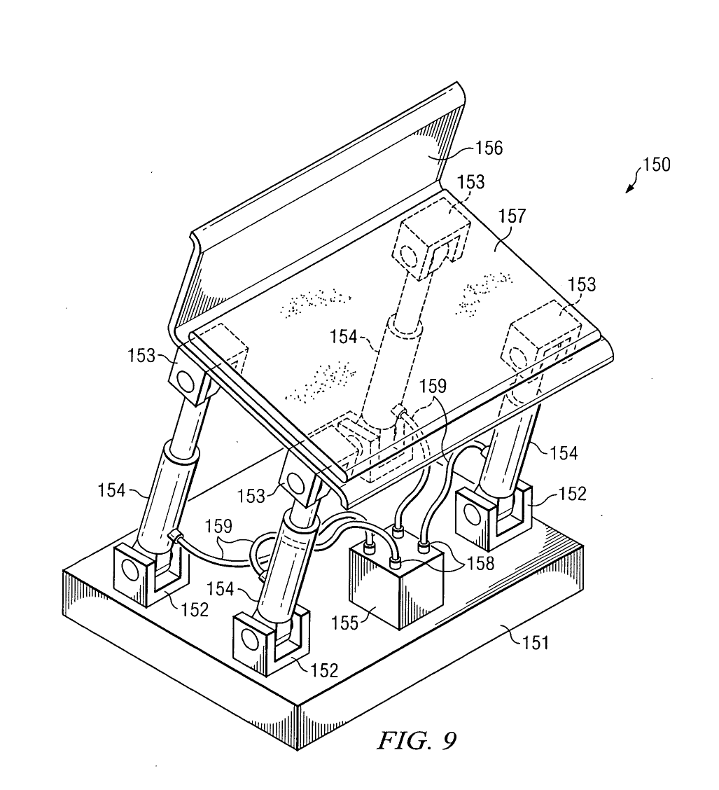

According to the non-limiting embodiment shown in FIG. 9, the means for positioning a subject in three-dimensional space may include base 151, a plurality of pistons 154, and chair 156. Each piston 154 may be operably coupled at each end to ball joints 152 and 153. Each ball joint 152 may be fixed to base 151. Each ball joint 153 may be fixed to chair 156 and may include a means to control the range of movement at the joint (a “movement governor,”). Each piston 154 may be connected to pump 155 by valve 158 and hose 159. Valves 158 may be independently or coordinately opened or closed to insert, hold, or vent hydraulic fluid. In addition, control over movement of pistons 154 relative to ball joints 153 may be exercised independently or coordinately with control of piston expansion. Thus, partly filling the rear pistons while using the movement governor to reversibly lock all ball joints 153 has the effect of tilting chair 156 toward the work space as shown in FIG. 9. In addition, this action moves chair 156 and a subject resting thereon toward the work space. Although not expressly shown, partially filling the front pistons 154 and fully filling the rear pistons 154 would elevate chair 156. By allowing some rotational movement of ball joints 153, the chair seat could be held in an level, elevated position, biased toward the work space. Other positions relative to the work space may be obtained by adjusting the volume of hydraulic fluid in each piston 154 and the range of motion permitted at each ball joint 153.

Chair 156 may be fitted with any type of ergonomic apparatus to increase the comfort and safety of the subject resting thereupon including, without limitation, cushion 157, arm rests, a waist belt, a shoulder harness, and instrument trays. Chair 156 may also be configured to include a support member that subjects straddle when seated. Although not expressly shown, this support member reduces the slippage and strain that a subject may experience while resting on chair 156 when it is tilted.

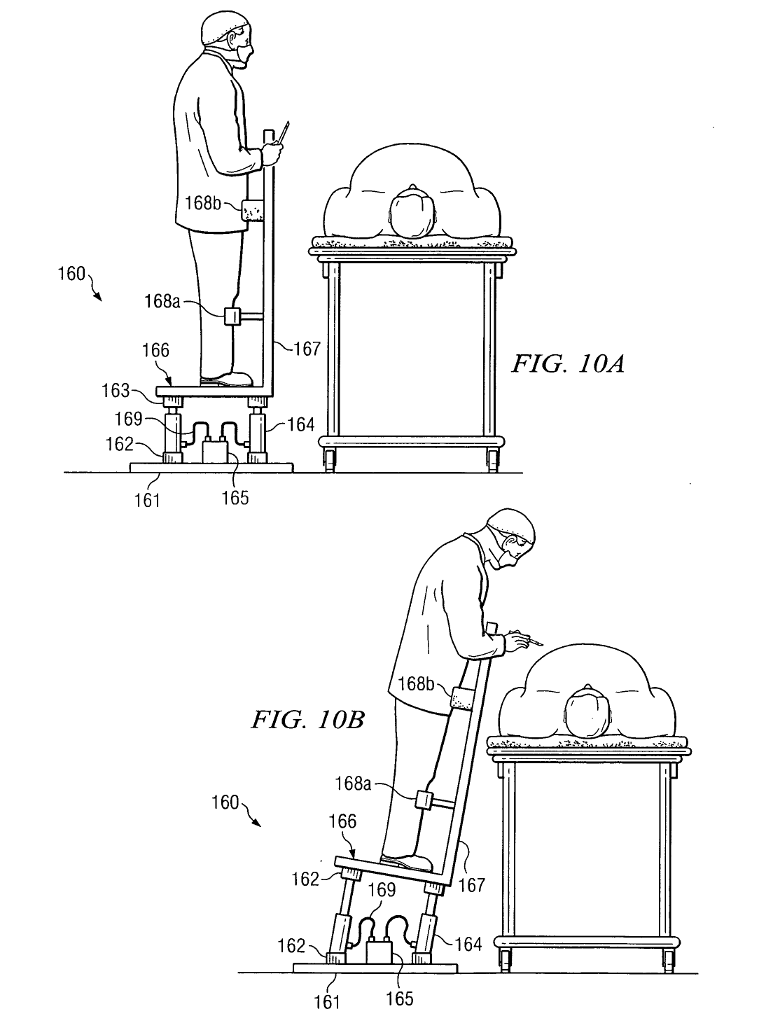

A variation of the non-limiting embodiment shown in FIG. 9 is shown in FIG. 10. Lift 160 differs from lift 150 in that platform 166 takes the place of chair 156 and supports a subject in an upright position as shown in FIG. 10A. Platform 166 may be configured with rail 167, which rises above platform 166 to about 75% of the height of the subject. Upon filling rear pistons 164, the subject is moved toward the work space, here a bariatric patient, in a slightly recumbent position as shown in FIG. 10B. This position allows some of the subjects weight to be borne by pads 168a and 168b, thereby reducing the subject's fatigue.

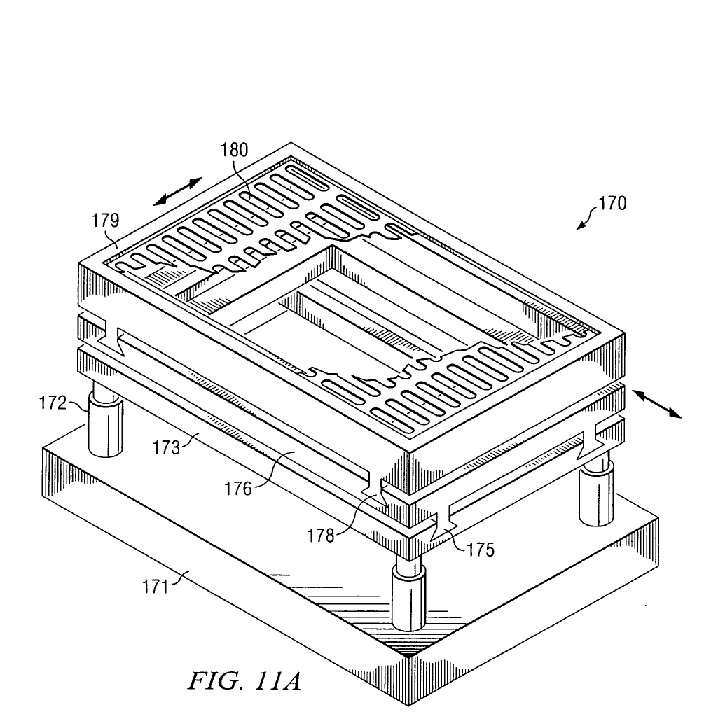

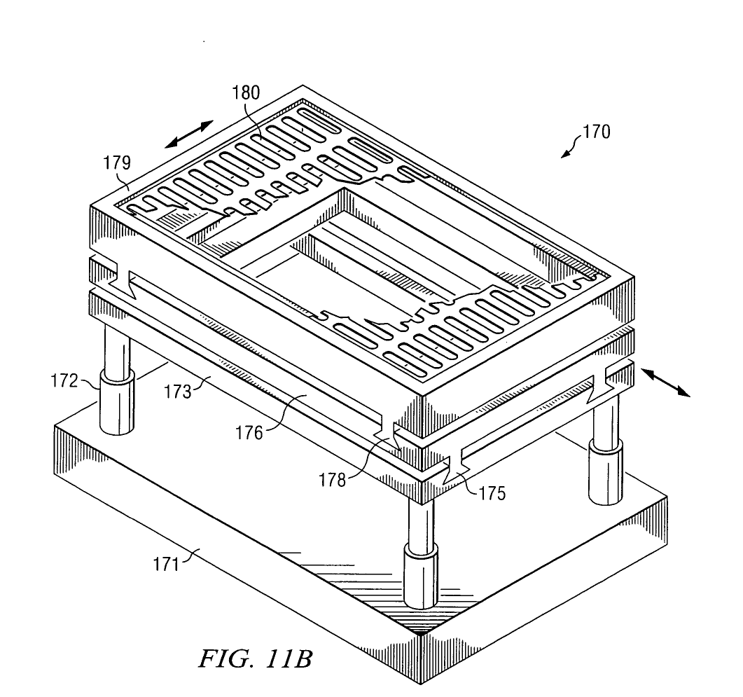

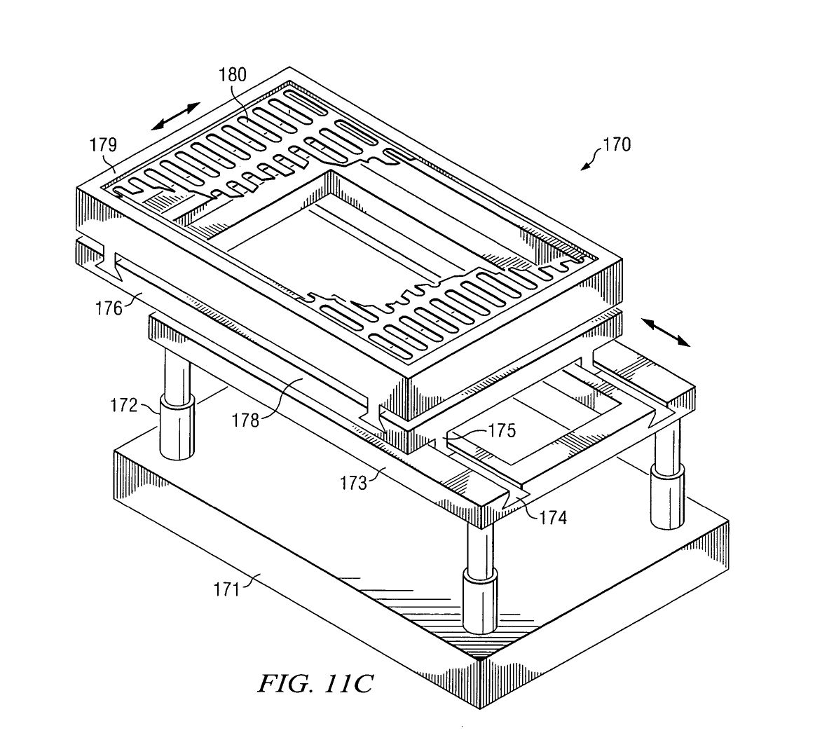

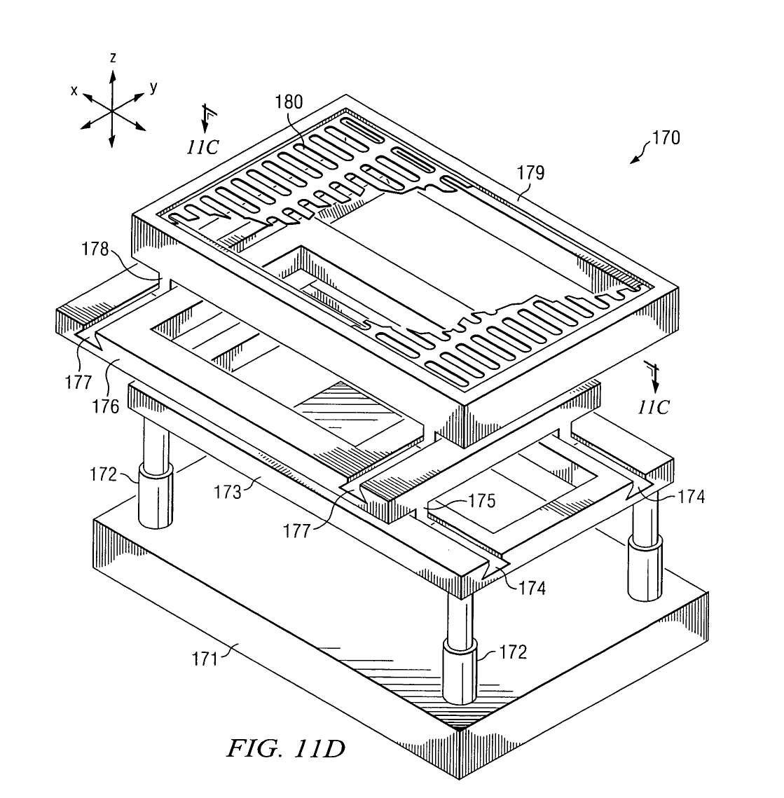

According to the non-limiting embodiment shown in FIG. 11, the means of moving a subject along a z-axis may comprise base 171, pistons 172, and layer 173. Pistons 172, like any pistons of the invention, may be gas pistons or hydraulic pistons. As shown in FIG. 11A, the lower end of each piston 172 may be mounted on base 171. The upper end of each piston 172 may be attached to z-layer 173. Expansion of pistons 172 is coordinated such that layer 173 is elevated as shown in FIG. 11B.

Also as shown in FIG. 11A, the means for moving a subject along an x-axis may include x-layer 176 and rail 175 operatively engaged in track 174. Although not expressly shown, rail 175 may be moved along track 174 by a motor either mounted on or in layer 173, layer 176 or base 171. For example, if a motor is included in the body of layer 173, it may be attached to a tire, wheel, or gear that engages rail 175 and moves it relative to track 174. Alternatively, if a motor is mounted on base 171, it may move rail 175 relative to track 174 through a systems of cables and pulleys (not expressly shown). In either case, movement along an x-axis is realized as shown in FIG. 11C.

Also as shown in FIG. 11A, the means for moving a subject along a y-axis may include platform 179 (or y-layer 179) and rail 178 operatively engaged in track 177. Although not expressly shown, rail 178 may be moved along track 177 by a motor either mounted on or in layer 176, platform 179 or base 171. For example, if a motor is included in the body of layer 176, it may be attached to a tire, wheel, or gear that engages rail 178 and moves it relative to track 177. Alternatively, if a motor is mounted on base 171, it may move rail 178 relative to track 177 through a systems of cables and pulleys (not expressly shown). In either case, movement along a y-axis is realized as shown in FIG. 11D. Movement of rails in tracks may be facilitated by application of lubricants. In addition, rail/track movement may be facilitated by use of bearings or other such means.

As shown in FIG. 11E, layer 173 and layer 176 may each have a center hole, which may be used, for example, to accommodate extending cables or other connections from these layers to a base-mounted motor. In addition, platform 179 may include grate 180. If lift 170 is used for surgical procedures which may result in the production of substantial waste fluids, platform 179 may be configured to include a drain (e.g. underlying grate 180; not expressly shown).

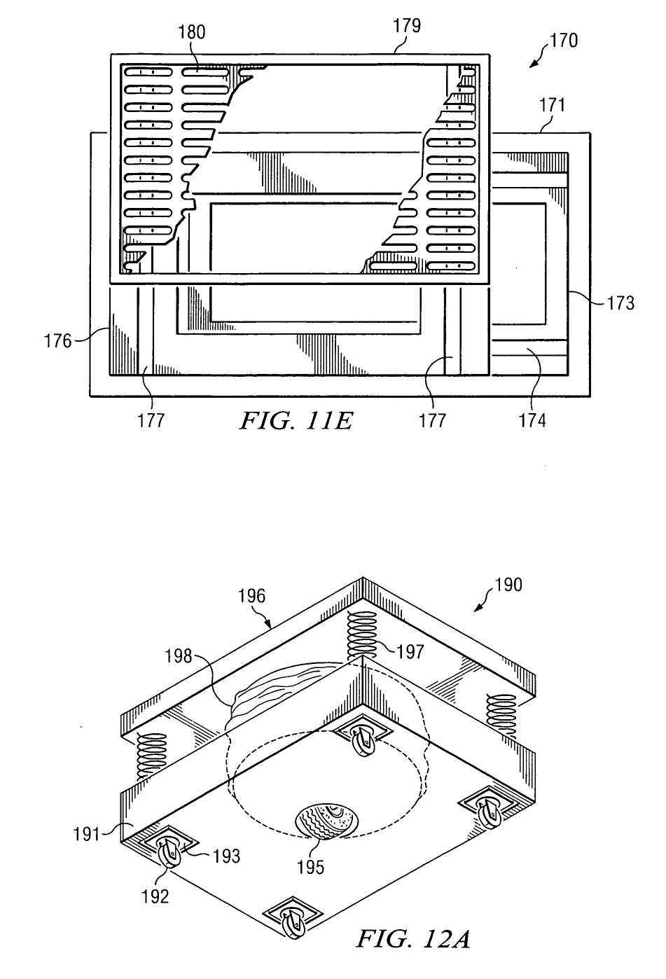

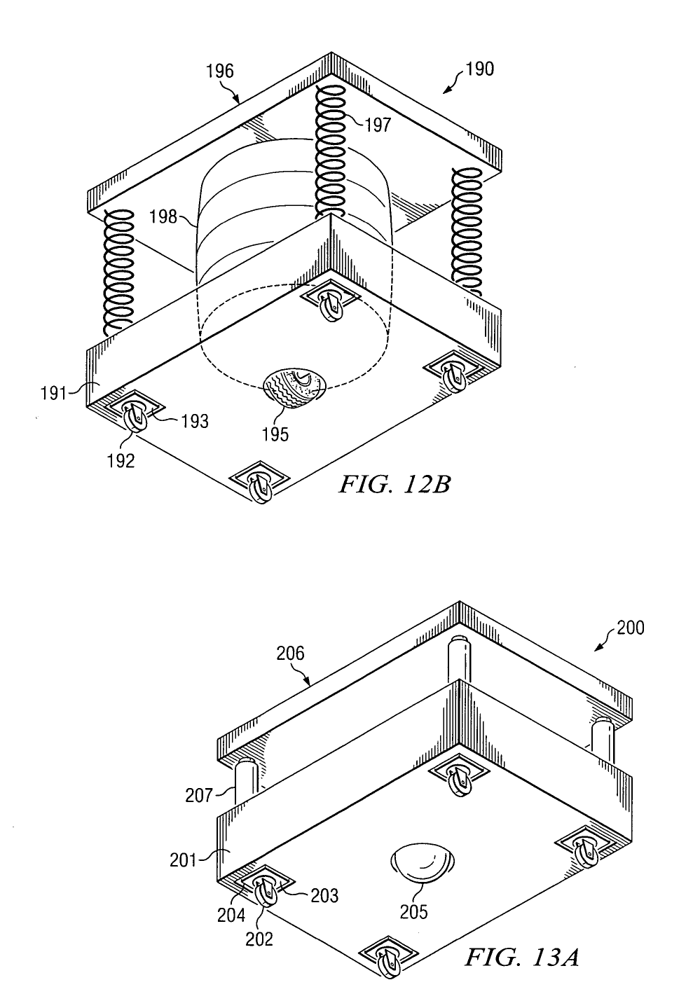

According to the non-limiting embodiment shown in FIG. 12, the means for moving a subject along a z-axis may include base 191, platform 196, a plurality of springs 197, and bladder 198. As shown in FIG. 12A, springs 197 are in their resting state and bladder 198 is deflated. Platform 196 may be raised from its start position shown in FIG. 12A to its elevated position shown in FIG. 12B by inflating bladder 198. In the elevated position, springs 197 are stretched such that as bladder 198 is deflated, springs 197 pull platform 196 back toward its start position. Although not expressly shown, bladder 198 may be donut-shaped with a pump positioned in the center void. The pump may be operably connected to bladder 198 and used to inflate or deflate bladder 198. Although not expressly shown, rods may be positioned along the center axis of each spring 197 such that they would not interfere with expansion or contraction of springs 197, but would block spring compression. This would prevent platform 196 from going so low as to damage bladder 198 and any other components between base 191 and platform 196.

Also as shown in FIG. 12A, the means for moving a subject in an x-y plane may include base 191, casters 192, retractable blocks 193, and drive tire 195 operably linked to a motor (not expressly shown). The orientation of drive tire 195 may be adjusted to direct movement of lift 190. A tiltable variation of the embodiment shown may be created by eliminating springs 197 and using four smaller bladders 198, one at each corner of platform 196. Synchronous and asynchronous movement at each corner may be achieved by operably linking these bladders to a suitable controller.

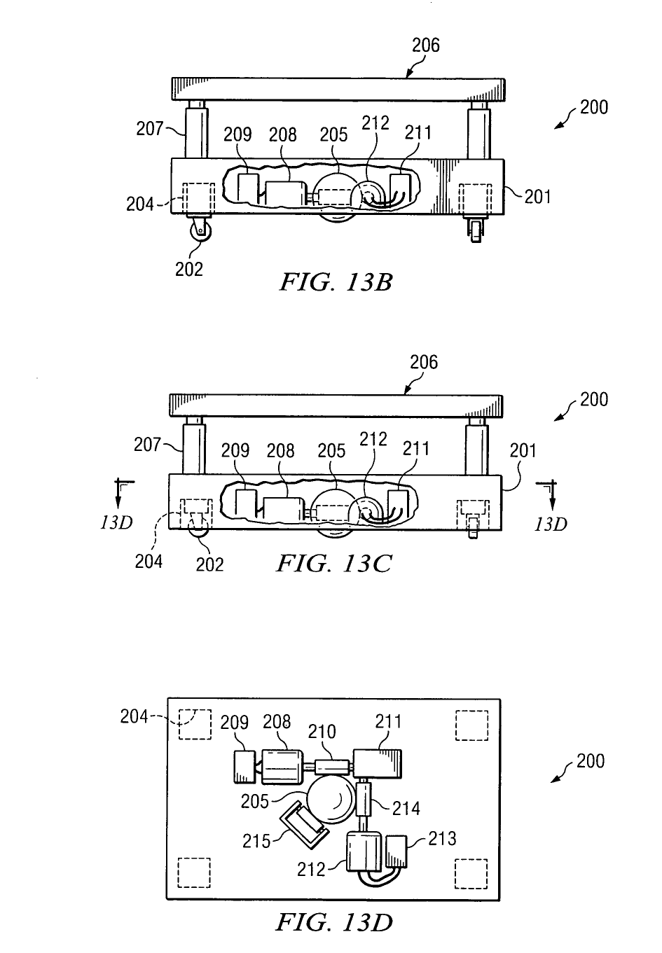

Another variation of the non-limiting embodiment shown in FIG. 12 is shown in FIG. 13. Lift 200 differs from lift 190 in that drive ball 205 takes the place of drive tire 195 (FIG. 13A).

As shown in FIG. 13B, casters 202 in their extended position raise drive ball 205 off the surface of the floor to facilitate transport and storage of lift 200. Once lift 200 is delivered to the location of intended use, such as an operating room, drive ball 205 may be contacted with the floor by retracting retractable blocks 203 on which casters 202 are fixed (FIG. 13C).

The direction of movement in the x-y plane depends on the direction of rotation of drive ball 205. This direction is determined by combined action of drive drums 210 and 214, which each contact drive ball 205. Thus, lift 200 may also include a controller that coordinates the revolutions per minute and direction of rotation of each drive drum. Motor 208 is operatively linked to drive drum 210. Likewise, motor 212 is operatively linked to drive drum 214. This linkage may be direct, as shown, or indirect. Where the linkage is indirect, one or more gears and belts may be used to rotate the drive drum(s). While not expressly shown, the present invention also contemplates other embodiments in which a single motor and a system of gears may determine the direction of rotation of drive ball 205. Motors 208 and 212 may be operatively linked to separate power sources 209 and 213, respectively, as shown in FIG. 13D. Alternatively, motors 208 and 212 may be operatively connected to a single power source (not expressly shown).

As shown in FIG. 13D, drive drums 210 and 214 lie within a plane, are oriented at a 90° angle relative to each other, and each contact drive ball 205. One or more tensioners may be used and each one may or may not be spring-loaded to help maintain contact between drive ball 205 and drive drums 210 and 214. In a relatively simple embodiment, tensioner 215 includes a drum or rod rotatably coupled to a support and is oriented such that the longitudinal axis of the rod or drum forms a right triangle with the longitudinal axes of drive drums 210 and 214. Tensioner 215 may or may not be in the same plane as drive drums 210 and 214. Drive drums 210 and 214 may be cylinder-shaped as shown in FIG. 13D. Alternatively, drive drums of the invention may have any suitable shape such as, for example, a wheel or tire shape. Drive drums of the invention may include a resilient covering with a high co-efficient of friction to enhance the transfer of movement to the drive ball.

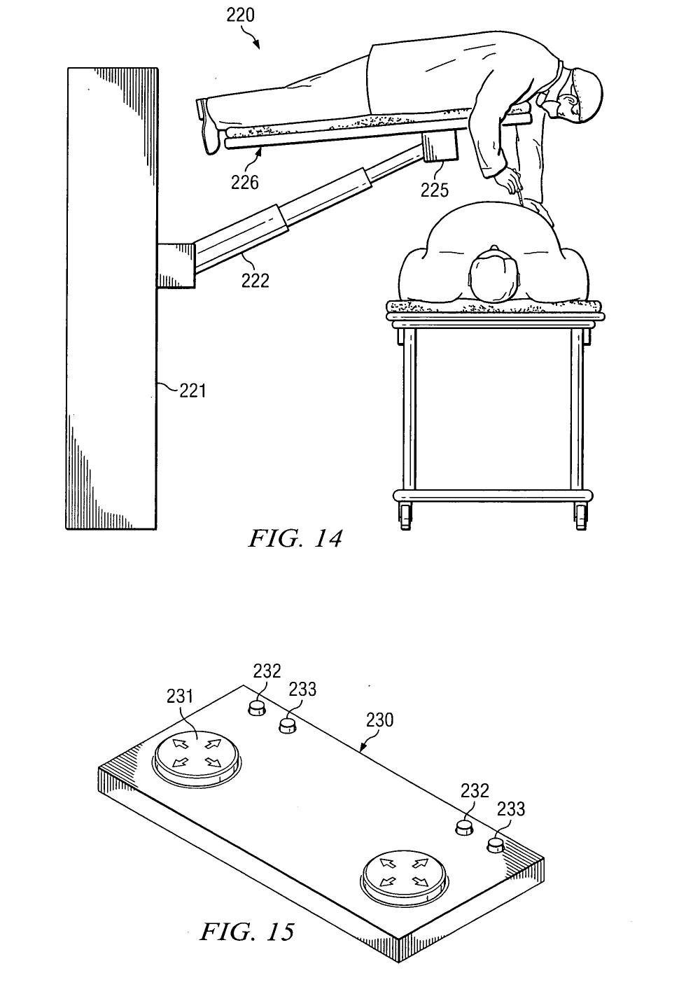

According to the non-limiting embodiment shown in FIG. 14, a lift of the invention may include vertical base 221, joint 222, hydraulic arm 222, joint 224, and platform 226. Lift 220 may also include, although not expressly shown, necessary pumps, motors, gears, and controls. According to this embodiment, a subject may be recumbently positioned relative to a work space. FIG. 14 shows one example where a surgeon is positioned above a particularly large bariatric patient. Platform 226 may be configured to include a head rest, foot-controls, voice-activated controls, instrument tray, conventional power plugs, lights, and proximity detectors (e.g. to avoid inadvertently bumping the patient).

Indeed, any lift of the invention may include any of the items listed in this description or combinations thereof. For example, lifts of the invention may include, without limitation, foot pads, low-rise rails, ridges, or bulges, safety railings, harnesses, arm rests, chairs, stools, foot-controls, voice-activated controls, instrument trays, standard or appliance power outlets (e.g. 110-120 volt, 15 amp, twin phase 60 Hz North American outlets or 220-240 volt, 30 amp, single phase 50 Hz European outlets), lights, gas pumps, vacuum pumps, suction hoses, fluid reservoirs, proximity detectors and combinations thereof. In addition, any portion of a lift of the invention may be covered with a non-woven material. These materials may be used, for example, to protect portions of the lift that may otherwise come into contact with patient fluids, tissues, or other biohazards. To prepare the lift for subsequent use (e.g. with another patient), the non-woven materials may be simply discarded as appropriate. Such use of non-woven materials may reduce the spread of infectious agents or other biohazards and may reduce the amount of cleaning and sanitizing required between surgeries .

According to the non-limiting embodiment shown in FIG. 15, platform 230 may include circular, touch-sensitive, foot control 231 that is raised above the upper surface of platform 230. Foot control 231 may have directional arrows molded into its surface for the operator's convenience. While not expressly shown, foot control 231 may be operably coupled with one or more means for moving a subject along an x-axis and a y-axis. Platform 230 may also include touch-sensitive up button 232 and touch-sensitive down button 233. These buttons may be operably liked to the means for moving a subject along a z-axis. They may be configured to raise or lower platform 230 at a fixed rate or at a rate determined by the pressure applied. Buttons 232 and 233 may be actuated by the subject's foot. Although not expressly shown, foot control 231 and buttons 232 and 233 may be recessed below the surface of platform 230 to minimize inadvertent contact.

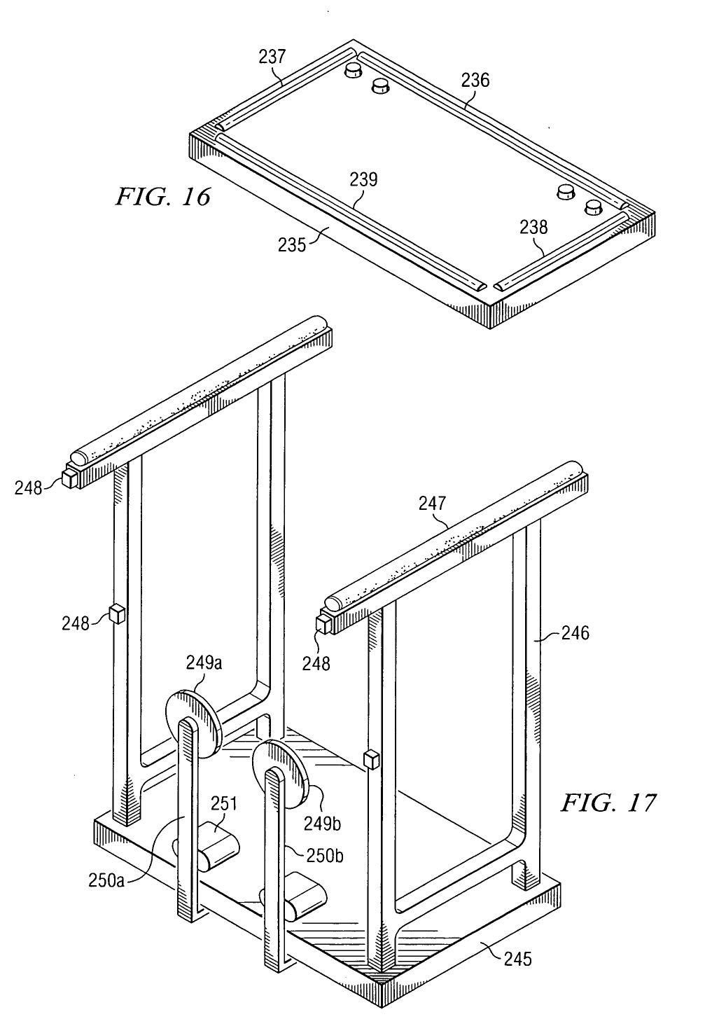

According to the non-limiting embodiment shown in FIG. 16, platform 235 may include contact-sensitive ridges. Forward ridge 236 and reverse ridge 239 may be operably connected to a means for moving a subject along a y-axis. Left ridge 237 and right ridge 238 may be operably connected to a means for moving a subject along an x-axis. Platform 235 may also include touch-sensitive up button 240 and touch-sensitive down button 241. These buttons may be operably liked to the means for moving a subject along a z-axis. They may be configured to raise or lower platform 235 at a fixed rate or at a rate determined by the pressure applied. Ridges 236, 237, 238, and 239 and buttons 240 and 241 may be actuated by the subject's foot.

According to the non-limiting embodiment shown in FIG. 17, the means for controlling platform movement includes pressure-sensitive knee pads 249a and 249brespectively mounted on arms 250a and 250b. Knee pads 249a and 249b may be configured in any ergonomic form to contact the subject's knees. For example, while not expressly shown, knee pads of the invention may partially or completely surround the subject's knees. Knee pads 249a and 249b may each be operably linked to a means for moving a subject along an x-axis according the invention. Thus, lateral pressure applied by the subject to either knee pad will result in positive or negative movement along the x-axis. Knee pads 249a and 249b may each be operably linked to a means for moving a subject along a y-axis according the invention. Thus, forward or reverse pressure applied by the subject to either knee pad will result in positive or negative movement along the y-axis. Alternatively, forward pressure to knee pad 249a may result in forward movement, while forward pressure on knee pad 249b may result in reverse movement.

Enclosed foot pedals 251a and 251b may be fixed on arms 250a and 250b as shown in FIG. 17. These pedals may be operably coupled to a means for moving a subject along a z-axis such that application of upward pressure by the subject will raise platform 245 and application of downward pressure will lower platform 245.

While not expressly shown, platforms of the invention may have any configuration. In some embodiments, for example, platforms are substantially planar. In other embodiments, the platform may be configured to include curves or steps. During a surgical procedure it may be necessary to move along the length (height) of a recumbant patient (e.g. moving from the head to the chest to the pelvis to the feet). On a planar platform in a level position, the bariatric surgeon may have to readjust the platform height each time. One option afforded the surgeon by lifts of the invention would be to simply tilt the platform such that it is higher near the patient's feet than at the patient's chest. Another option provided by the invention is a platform that includes a slope or stair-step configuration. In applications where the subject may experience discomfort from standing on a sloped surface, a stair-step or other contour may be preferred.

Although the present invention and its advantages have been described in detail, it should be understood that various changes, substitutions and alternations can be made herein without departing from the spirit and scope of the invention as defined by the following claims.

TABLE 1

| No. | Feature Name | FIGS. |
|---|---|---|
| 10 | lift | 1A, 1B |
| 11 | base | 1A, 1B |
| 12 | scissor truss | 1A, 1B |
| 13 | screw | 1A, 1B |
| 14 | joint | 1A, 1B |
| 15 | joint | 1A, 1B |
| 16 | platform | 1A, 1B, 1C |
| 17 | perimeter angled rail | 1A, 1B, 1C |
| 18 | foot pad | 1C |
| 19 | foot pad | 1C |
| 20 | lift | 2A, 2B |
| 21 | base | 2A, 2B |
| 22 | truss | 2A, 2B |
| 23 | screw | |
| 24 | threaded ring | 2A, 2B |
| 25 | threaded ring | 2A, 2B |
| 26 | platform | 2A, 2B, 2C |
| 27 | perimeter ridge | 2A, 2B, 2C |
| 28 | strut | 2A, 2B |
| 29 | strut | 2A, 2B |
| 30 | mount | 2A, 2B |
| 31 | mount | 2A, 2B |
| 32 | threaded rod | 2A, 2B |
| 33 | motor | 2A, 2B |
| 40 | lift | 3A, 3B, 3C |
| 41 | base | 3A, 3B, 3C |
| 42 | truss | 3A, 3B, 3C |
| 43 | screw | 3A, 3B, 3C |
| 44 | threaded ring | 3A, 3B, 3C |
| 45 | threaded ring | 3A, 3B, 3C |
| 46 | platform | 3A, 3B, 3C, 3D |
| 47 | perimeter bulge | 3A, 3B, 3C, 3D |
| 48a | strut | 3A, 3B, 3C |
| 48b | strut | 3A, 3B, 3C |
| 49a | strut | 3A, 3B, 3C |
| 49b | strut | 3A, 3B, 3C |
| 50 | mount | 3A, 3B, 3C |
| 51 | mount | 3A, 3B, 3C |
| 52 | threaded rod | 3A, 3B, 3C |
| 53 | motor | 3A, 3B, 3C |
| 54 | threaded ring | 3B |
| 55 | threaded ring | 3A, 3B, 3C |
| 56 | motor | 3A, 3B, 3C |
| 60 | lift | 4A, 4B |
| 61 | base | 4A, 4B |
| 62a | piston | 4A, 4B |
| 62b | chamber | 4A, 4B |
| 63a | piston | 4A, 4B |
| 63b | chamber | 4A, 4B |
| 64 | motor | 4A, 4B |
| 65 | valve | 4A, 4B |
| 66 | platform | 4A, 4B, 4C |
| 67 | perimeter rail | 4A, 4B, 4C |
| 68 | foot pad | 4C |
| 69 | foot pad | 4C |
| 70 | lift | 5A. 5B |
| 71 | base | 5A, 5B, 5C |
| 72 | weight | 5A, 5B |
| 73 | jack | 5A, 5B |
| 74 | gear | 5A, 5B |
| 75 | arm | 5A, 5B, 5C |
| 76 | platform | 5A, 5B, 5C |
| 77 | support | 5A, 5B |
| 78 | foot pad | 5C |
| 79 | foot pad | 5C |
| 80 | elongated gear | 5A, 5B |
| 83 | motor | 5A, 5B |
| 90 | lift | 6B, 6C |
| 91 | base | 6A, 6B, 6C |
| 92 | bearing | 6A |
| 93 | threaded piston | 6A |
| 94 | threaded cylinder | 6A |
| 95 | belt | 6A, 6B, 6C |
| 96 | platform | 6A, 6B, 6C |
| 97 | rail | 6A, 6B, 6C |
| 103 | motor | 6B, 6C |
| 110 | lift | 7B, 7C, 7D, 7E |
| 111 | base | 7A, 7B, 7C, 7D, 7E |
| 113 | threaded piston | 7A, 7B, 7C, 7D, 7E |
| 114 | threaded sleeve | 7A, 7B, 7C, 7D, 7E |
| 115 | belt | 7A, 7B, 7C, 7D, 7E |
| 116 | platform | 7A, 7B, 7C, 7D, 7E |
| 117 | rail | 7B, 7C, 7D, 7E |
| 118 | clutch | 7A, 7B, 7C, 7D, 7E |
| 123 | motor | 7B, 7C, 7D, 7E |
| 124 | motor | 7A |
| 126 | resilient annulus | 7A |
| 127 | clutch | 7A |
| 128 | ball | 7A |
| 129 | socket | 7A |
| 130 | lift | 8A, 8B, 8C, 8D |
| 131 | base | 8A, 8B, 8C, 8D |
| 132 | motor | 8A, 8B |
| 133 | gear box | 8A, 8B |
| 134 | piston | 8A, 8B, 8C, 8D |
| 136 | platform | 8A, 8B, 8C, 8D |
| 137 | rail | 8A, 8B, 8C, 8D |
| 138 | arm | 8A, 8B, 8C, 8D |
| 139 | shin rest | 8A, 8B, 8C, 8D |
| 140 | threaded gear | 8A, 8B, 8C, 8D |
| 141 | elongated gear rod | 8A, 8B, 8C, 8D |
| 142 | threaded rod | 8A, 8B, 8C, 8D |
| 143 | y-motor | 8A, 8B, 8C, 8D |
| 144 | motor | 8A, 8B, 8C, 8D |
| 145 | support | 8A, 8B, 8C, 8D |
| 146 | support | 8C, 8D |
| 147 | hub | 8D |
| 148 | hub | 8D |
| 150 | lift | 9 |
| 151 | base | 9 |
| 152 | ball joint | 9 |
| 153 | ball joint | 9 |
| 154 | piston | 9 |
| 155 | pump | 9 |
| 156 | chair | 9 |
| 157 | cushion | 9 |
| 158 | valve | |
| 159 | hose | |
| 160 | lift | 10A, 10B |
| 161 | base | 10A, 10B |
| 162 | ball joint | 10A, 10B |
| 163 | ball joint | 10A, 10B |
| 164 | piston | 10A, 10B |
| 165 | pump | 10A, 10B |
| 166 | platform | 10A, 10B |
| 167 | rail | 10A, 10B |
| 168a | shin pad | 10A, 10B |
| 168b | torso pad | 10A, 10B |
| 169 | hose | 10A, 10B |
| 170 | lift | 11A, 11B, 11C |
| 171 | base | 11A, 11B, 11C |
| 172 | piston | 11A, 11B, 11C |
| 173 | z-layer | 11A, 11B, 11C |
| 174 | track | 11A, 11B, 11C |
| 175 | rail | 11A, 11B, 11C |
| 176 | x-layer | 11A, 11B, 11C |
| 177 | track | 11A, 11B, 11C |
| 178 | rail | 11A, 11B, 11C |
| 179 | platform | 11A, 11B, 11C |
| 180 | grate | 11A, 11B, 11C |
| 190 | lift | 12A, 12B |
| 191 | base | 12A, 12B |
| 192 | castor | 12A, 12B |
| 193 | retractable block | 12A, 12B |
| 194 | castor well | 12A, 12B |
| 195 | tire | 12A, 12B |
| 196 | platform | 12A, 12B |
| 197 | spring | 12A, 12B |
| 198 | bladder | 12A, 12B |
| 200 | lift | 13A, 13B, 13C |
| 201 | base | 13A, 13B, 13C, 13D |
| 202 | castor | 13A, 13B, 13C, 13D |
| 203 | retractable block | 13A, 13B, 13C, 13D |
| 204 | castor well | 13A, 13B, 13C, 13D |
| 205 | drive ball | 13A, 13B, 13C, 13D |
| 206 | platform | 13A, 13B, 13C, 13D |
| 207 | piston | 13A, 13B, 13C |
| 208 | motor | 13B, 13C, 13D |
| 209 | power source | 13B, 13C, 13D |
| 210 | drive drum | 13B, 13C, 13D |
| 211 | support | 13B, 13D |
| 212 | motor | 13B, 13C, 13D |
| 213 | power source | 13B, 13C, 13D |
| 214 | drive drum | 13B, 13C, 13D |
| 215 | tensioner | 13D |
| 220 | lift | 14 |
| 221 | base | 14 |
| 222 | hydraulic arm | 14 |
| 225 | ball joint | 14 |
| 226 | platform | 14 |
| 230 | platform | 15 |
| 231 | direction switch | 15 |
| 232 | down button | 15 |
| 233 | up button | 15 |
| 235 | platform | 16 |
| 236 | forward ridge | 16 |
| 237 | left ridge | 16 |
| 238 | right ridge | 16 |
| 239 | rear ridge | 16 |
| 240 | down button | 16 |
| 241 | up button | 16 |
| 245 | platform | 17 |
| 246 | rail | 17 |
| 247 | pad | 17 |
| 248 | proximity detectors | 17 |
| 249 | knee pad | 17 |
| 250 | arm | 17 |
| 251 | foot pedal | 17 |

What is claimed is:

1. A lift for vertically positioning a subject relative to a work space comprising:
a base;
an vertically and reversibly expandable support positioned above and fixed to the base,
a platform positioned above and fixed to the vertically and reversibly expandable support; and
a controller operably linked to the vertically and reversibly expandable support,
wherein the controller is selected from the group consisting of a foot-operated controller, a knee-operated controller, a head-operated controller, a voice-operated controller, and combinations thereof.

2. The lift according to claim 1, wherein the vertically and reversibly expandable support is selected from the group consisting of a scissor truss, an inflatable bladder, a piston, a jack, a spring, a screw and combinations thereof.

3. The lift according to claim 1, wherein the platform is tiltable.

4. The lift according to claim 1, wherein the controller may be operated by the subject while the subject maintains visual and tactile contact with the work space.

5. The lift according to claim 1 further comprising:
a drive implement operably linked to the base;
a motor operably linked to the drive implement;
a drive implement controller operably linked to the drive implement, the motor, or both the drive implement and the motor; and
a plurality of casters rotatably fixed to the lower surface of the base,
wherein (a) the lowest point of the drive implement and the lowest point of each caster are in a plane parallel to the plane of the base and (b) the drive implement controller controls the direction, distance, and speed of lift movement in a plane parallel to the plane of the base.

6. The lift according to claim 1, wherein the work space is a surgical field.

7. A lift for positioning a subject relative to a work space comprising:
a tiltable platform;
a means of moving a subject relative to an x-axis;
a means of moving a subject relative to a y-axis that is perpendicular to the x-axis;
a means of moving a subject relative to a z-axis that is perpendicular to the x-axis and perpendicular to the y-axis; and
a controlling means operably linked to the means of moving a subject along an x-axis, the means of moving a subject along an y-axis, and the means of moving a subject along an z-axis,
wherein the controlling means may be actuated by the subject while maintaining visual and tactile contact with the work space.

8. The lift according to claim 7, wherein the controlling means comprises controls selected from the group consisting of foot-operated controls, knee-operated controls, head-operated controls, voice-operated controls, and combinations thereof.

9. The lift according to claim 8, wherein the controlling means comprises foot-operated controls.

10. The lift according to claim 8, wherein the controlling means comprises knee-operated controls.

11. The lift according to claim 8, wherein the controlling means comprises voice-operated controls.

12. The lift according to claim 7 further comprising a non-woven material.

13. The lift according to claim 7 further comprising an item selected from the group consisting of a foot pad, a low-rise rail, a low-rise ridge, a low-rise bulge, a safety railing, a body harness, an appendage harness, an arm rest, a chair, an instrument tray, a power outlet, a light, a gas pump, a vacuum pump, a suction hose, a fluid reservoir, a proximity detector, and combinations thereof.

14. A portable lift for positioning a subject relative to a work space comprising:
a base having an upper surface and a lower surface;
a drive implement operably linked to the base;
a motor operably linked to the drive implement;
a plurality of casters rotatably fixed to the lower surface of the base;
a vertical lift operably linked to the base;
a platform operably linked to the vertical lift; and
a controller operably linked to the drive implement and operably linked to the lift.

15. The lift according to claim 14, wherein the drive implement is selected from the group consisting of a drive ball and a drive wheel.

16. The lift according to claim 15, wherein the drive implement is a drive wheel.

17. The lift according to claim 16 further comprising a flexible drive shaft fixed at one end to the drive wheel and fixed at the other end to the motor.

18. The lift according to claim 16 further comprising a gear box and a flexible drive shaft, wherein the flexible drive shaft is fixed at one end to the drive wheel and rotatably coupled at the other end to the gear box and wherein the gear box is operably linked to the motor.

19. The lift according to claim 14, wherein the casters are retractable into the base.

20. The lift according to claim 14, wherein the controller is selected from the group consisting of a foot-operated controller, a knee-operated controller, a head-operated controller, a voice-operated controller, and combinations thereof.

21. The lift according to claim 14 further comprising a non-woven material removably attached to any portion of the lift.

22. The lift according to claim 14 further comprising an item selected from the group consisting of a foot pad, a low-rise rail, a low-rise ridge, a low-rise bulge, a safety railing, a body harness, an appendage harness, an arm rest, a chair, an instrument tray, a power outlet, a light, a gas pump, a vacuum pump, a suction hose, a fluid reservoir, a proximity detector, and combinations thereof.

23. A lift for positioning a subject relative to a work space comprising:
a base having an upper surface and a lower surface;
a plurality of base ball joints fixed to the upper surface of the base;
a plurality of pistons, each having an upper and lower end and each operably linked at the lower end to one base ball joint;
a plurality of platform ball joints, each operably linked to the upper end of one piston;
a platform having an upper and lower surface and fixed to the platform ball joints by its lower surface;
a plurality of valves, each operably linked to at least one piston;
a pump operably linked to at least one valve; and
a controller operably linked to each valve to regulate influx and outflow of material from the piston linked thereto,
wherein the number of pistons is half the sum of the number of base ball joints and the number of platform ball joints.

24. The lift according to claim 23 further comprising a plurality of movement governors, each operably linked to a platform ball joint to regulate the range of motion of the ball joint.

25. The lift according to claim 23, wherein the controller is selected from the group consisting of a foot-operated controller, a knee-operated controller, a head-operated controller, a voice-operated controller, and combinations thereof.

26. The lift according to claim 23 further comprising a non-woven material removably attached to any portion of the lift.

27. The lift according to claim 23 further comprising an item selected from the group consisting of a foot pad, a low-rise rail, a low-rise ridge, a low-rise bulge, a safety railing, a body harness, an appendage harness, an arm rest, a chair, an instrument tray, a power outlet, a light, a gas pump, a vacuum pump, a suction hose, a fluid reservoir, a proximity detector, and combinations thereof.

28. A method of manufacturing a lift for positioning a subject relative to a work space comprising:
forming a means of moving a subject along an x-axis;
forming a means of moving a subject along an z-axis;
forming a means of moving a subject along an y-axis; and
forming a controlling means operably linked to the means of moving a subject along an x-axis, the means of moving a subject along an z-axis, and the means of moving a subject along an y-axis,
wherein the controlling means may be actuated by the subject while maintaining visual and tactile contact with the work space.

29. A method of positioning a subject relative to a work space comprising:
conveying the subject on a lift having:
a means of moving a subject along an x-axis;
a means of moving a subject along an z-axis;
a means of moving a subject along an y-axis; and
a controlling means operably linked to the means of moving a subject along an x-axis, the means of moving a subject along an z-axis, and the means of moving a subject along an y-axis,
wherein the controlling means may be actuated by the subject while maintaining visual and tactile contact with the work space.

30. The method according claim 29 further comprising conveying the subject in an erect, partially recumbent, or fully-recumbent posture.

31. The method according claim 29 further comprising continuously, intermittently, or periodically adjusting the position of the lift relative to the work space.
